(19) United States
(12) Patent Application Publication
(10) Pub. No.: US 2026/0061889 A1
(43) Pub. Date: Mar. 5, 2026

(54) METHOD FOR CONTROLLING POWER SUPPLY AND VEHICLE IN WHICH CONTROL OF POWER SUPPLY IS PERFORMED BY THE METHOD

(71) Applicants: Hyundai Motor Company, Seoul (KR); Kia Corporation, Seoul (KR)

(72) Inventors: Chan Seok Choi, Hwaseong-si (KR); Byoungcheol Jeong, Hwaseong-si (KR); Seungmin Kim, Hwaseong-si (KR); Gwangseob Kim, Hwaseong-si (KR)

(21) Appl. No.: 19/236,504

(22) Filed: Jun. 12, 2025

(30) Foreign Application Priority Data
Aug. 29, 2024 (KR) 10-2024-0117004

(51) Int. Cl. B60L 58/20; B60L 1/00; B60L 58/12; B60W 10/26

(52) U.S. Cl. CPC B60L 58/20; B60L 1/00; B60L 58/12; B60W 10/26; B60W 2710/305

(57) ABSTRACT

In an embodiment a method includes determining, by a processor of a vehicle, whether an ignition circuit of a vehicle is in an ON state or an OFF state, based on determining that the ignition circuit is in the ON state, charging, by the processor, an auxiliary battery of the vehicle by using a high-voltage battery of the vehicle and based on determining that the ignition circuit is in the OFF state, determining, by the processor, whether a crash of the vehicle is detected. The method further includes based on detecting the crash, controlling, by the processor, the auxiliary battery to supply power to an airbag control unit (ACU) of the vehicle and based on not detecting the crash, charging, by the processor, the auxiliary battery by using a low-voltage battery of the vehicle.

### CROSS-REFERENCE TO RELATED APPLICATIONS

This application claims priority to and the benefit of Korean Patent Application No. 10-2024-0117004 filed in the Korean Intellectual Property Office on Aug. 29, 2024, the entire contents of which are incorporated herein by reference.

### TECHNICAL FIELD

The present disclosure relates to a method for controlling power supply and a vehicle in which the control of power supply is performed by the method.

### BACKGROUND

Recently, a vehicle may include various electronic devices and controllers, and these devices perform an important function in improving the safety and convenience of the vehicle. In particular, the important function such as airbag deployment or door unlocking during a vehicle crash may be essential to protect the lives of passengers and respond appropriately to an emergency situation after the crash. In order for the function to be operated smoothly, stable power supply needs to be guaranteed for a certain time after the crash. Conventionally, an additional power supply device such as a coin-type battery or a capacitor is installed in the controller to supply power required even when main power (e.g., 12 V battery or high-voltage battery) is cut off after the vehicle crash. The device may provide temporary power immediately after the crash to normally perform the function such as the airbag deployment or the door unlocking.

However, it may become mandatory to record whether an external communication controller transmits an emergency call (eCall) in an EDR module of an airbag control unit (ACU) when the crash occurs in accordance with strengthened event data recorder (EDR) regulations in Europe. This new mandate has led to a need for increasing a power maintenance time, i.e., operating time, of a main controller such as the ACU or a central communication unit (CCU) after the crash. The important control function such as the EDR recording may not be performed properly after capacitor power is exhausted while the main power is cut off when the crash occurs.

### SUMMARY

Embodiments provide a method for controlling power supply in which variable auxiliary power is provided to a controller emergency purposes while minimizing a change to a conventional system, and a vehicle in which the control of power supply is performed by the method.

According to an embodiment, provided is a method for controlling power supply in which power supply in a vehicle is controlled by a computing device mounted in the vehicle and including a processor and a storage medium, the method including: determining, by the processor, whether a second ignition circuit IGN2 of the vehicle is in an ON state; charging, by the processor, an auxiliary battery mounted in the vehicle by using a high-voltage battery of the vehicle if the second ignition circuit IGN2 is determined to be in the ON state; detecting, by the processor, a vehicle crash if the second ignition circuit IGN2 is determined to be in an OFF state; controlling, by the processor, the auxiliary battery to supply power to an airbag control unit (ACU) of the vehicle if the vehicle crash is detected; and charging, by the processor, the auxiliary battery by using a 12 V battery of the vehicle if the vehicle crash is not detected.

The controlling the auxiliary battery to supply the power to the ACU of the vehicle may include, controlling, by the processor, the auxiliary battery to supply the power also to a central communication unit (CCU) of the vehicle.

The charging the auxiliary battery by using the high-voltage battery of the vehicle may include: determining, by the processor, whether a state of charge (SOC) of the auxiliary battery is a predetermined first threshold or more; starting, by the processor, charging the auxiliary battery by using the high-voltage battery if the SOC of the auxiliary battery is determined to be less than the first threshold; and terminating, by the processor, the charging if the SOC of the auxiliary battery is determined to be the first threshold or more after the charging starts.

The charging the auxiliary battery by using the 12 V battery of the vehicle may include: determining, by the processor, whether a state of charge (SOC) of the auxiliary battery is a predetermined second threshold or more; determining, by the processor, a state of charge (SOC) of the 12 V battery is a predetermined third threshold or more if the SOC of the auxiliary battery is determined to be less than the second threshold; starting, by the processor, charging the auxiliary battery by using the 12 V battery if the SOC of the 12 V battery is determined to be the third threshold or more; and terminating, by the processor, the charging if the SOC of the auxiliary battery is determined to be the second threshold or more after the charging starts.

The vehicle may further include a power-net domain controller (PDC) operated between the auxiliary battery and a controller, and the method may further include: receiving, by the PDC, a parking power supply request signal from the controller; determining, by the PDC, which battery between the 12 V battery and the auxiliary battery to supply the power to the controller based on the parking power supply request signal; and controlling, by the processor, the battery determined by the PDC to supply the power to the controller.

The determining which battery between the 12 V battery and the auxiliary battery to supply the power to the controller may include: determining, by the PDC, whether a state of charge (SOC) of the 12 V battery is a predetermined fourth threshold or more; and determining, by the PDC, the 12 V battery as the battery to supply the power to the controller if the SOC of the 12 V battery is determined to be the fourth threshold or more.

The determining which battery between the 12 V battery and the auxiliary battery to supply the power to the controller may include: determining, by the PDC, whether a state of charge (SOC) of the auxiliary battery is a predetermined fifth threshold or more if the SOC of the 12 V battery is determined to be less than the fourth threshold; and determining, by the PDC, the auxiliary battery as the battery to supply the power to the controller if the SOC of the auxiliary battery is determined to be the fifth threshold or more.

According to an embodiment, provided is a method for controlling power supply in which power supply in a vehicle is controlled by a computing device mounted in the vehicle and including a processor and a storage medium, the method including: detecting, by the processor, a crash through a front impact sensor (FIS) of the vehicle; checking, by the processor, whether power supplied from a high-voltage battery of the vehicle and power supplied from a 12 V battery of the vehicle are lost if the crash is detected; controlling, by the processor, an auxiliary battery mounted in the vehicle to supply the power to the airbag control unit (ACU) and central communication unit (CCU) of the vehicle if the power supplied from the high-voltage battery and the power supplied from the 12 V battery are checked to be lost; outputting, by the ACU, a crash signal to the CCU and a data connectivity unit (DCU) of the vehicle; receiving, by the ACU, an emergency call (eCall) signal triggered from the DCU based on the crash signal; and recording, by the ACU, an eCall status in an event data recorder (EDR).

The outputting, by the ACU, the crash signal to the CCU and the DCU of the vehicle may include: outputting, by the ACU, the crash signal to the CCU through a controller area network (CAN); outputting, by the CCU, the crash signal to the DCU through Ethernet; and outputting, by the ACU, the crash signal to the DCU through pulse-width modulation (PWM).

The receiving, by the ACU, the eCall signal triggered from the DCU may include: receiving, by the CCU, the eCall signal from the DCU through the Ethernet; and receiving, by the ACU, the eCall signal from the CCU through the CAN.

According to an embodiment, provided is a vehicle including: a computing device including a processor and a storage medium; a high-voltage battery, a 12 V battery, and an auxiliary battery, supplying power; an airbag control unit (ACU); and a central communication unit (CCU), wherein the processor performs: detecting a vehicle crash; and controlling the auxiliary battery to supply the power to the ACU and the CCU if the crash is detected.

The detecting the vehicle crash may include: determining whether a second ignition circuit IGN2 of the vehicle is in an ON state; charging the auxiliary battery by using the high-voltage battery of the vehicle if the second ignition circuit IGN2 is determined to be in the ON state; detecting the vehicle crash if the second ignition circuit IGN2 is determined to be in an OFF state; and charging the auxiliary battery by using the 12 V battery of the vehicle if the vehicle crash is not detected.

The charging the auxiliary battery by using the high-voltage battery of the vehicle may include: determining whether a state of charge (SOC) of the auxiliary battery is a predetermined first threshold or more; starting charging the auxiliary battery by using the high-voltage battery if the SOC of the auxiliary battery is determined to be less than the first threshold; and terminating the charging if the SOC of the auxiliary battery is determined to be the first threshold or more after the charging starts.

The charging the auxiliary battery by using the 12 V battery of the vehicle may include: determining whether a state of charge (SOC) of the auxiliary battery is a predetermined second threshold or more; determining whether a state of charge (SOC) of the 12 V battery is a predetermined third threshold or more if the SOC of the auxiliary battery is determined to be less than the second threshold; starting charging the auxiliary battery by using the 12 V battery if the SOC of the 12 V battery is determined to be the third threshold or more; and terminating the charging if the SOC of the auxiliary battery is determined to be the second threshold or more after the charging starts.

The vehicle may further include: a controller; and a power-net domain controller (PDC) operated between the auxiliary battery and the controller, and wherein the PDC performs: receiving a parking power supply request signal from the controller; and determining which battery between the 12 V battery and the auxiliary battery to supply the power to the controller based on the parking power supply request signal, and the processor performs controlling the battery determined by the PDC to supply the power to the controller.

The determining which battery between the 12 V battery and the auxiliary battery to supply the power to the controller may include: determining whether a state of charge (SOC) of the 12 V battery is a predetermined fourth threshold or more; and determining the 12 V battery as the battery to supply the power to the controller if the SOC of the 12 V battery is determined to be the fourth threshold or more.

The determining which battery between the 12 V battery and the auxiliary battery to supply the power to the controller may include: determining whether a state of charge (SOC) of the auxiliary battery is a predetermined fifth threshold or more if the SOC of the 12 V battery is determined to be less than the fourth threshold; and determining the auxiliary battery as the battery to supply the power to the controller if the SOC of the auxiliary battery is determined to be the fifth threshold or more.

The detecting the vehicle crash may include: detecting the crash through a front impact sensor (FIS) of the vehicle; and the controlling the auxiliary battery to supply the power to the ACU and the CCU if the crash is detected includes: checking whether the power supplied from the high-voltage battery and the power supplied from the 12 V battery are lost if the crash is detected; and controlling the auxiliary battery mounted in the vehicle to supply the power to the ACU and the CCU of the vehicle if the power supplied from the high-voltage battery and the power supplied from the 12 V battery are checked to be lost; and wherein the ACU performs: outputting a crash signal to the CCU and a data connectivity unit (DCU) of the vehicle, receiving an emergency call (eCall) signal triggered from the DCU based on the crash signal, and records an eCall status in an event data recorder (EDR).

The outputting the crash signal to the CCU and the DCU of the vehicle may include: outputting, by the ACU, the crash signal to the CCU through a controller area network (CAN); outputting, by the CCU, the crash signal to the DCU through Ethernet; and outputting, by the ACU, the crash signal to the DCU through pulse-width modulation (PWM).

The receiving the eCall signal triggered from the DCU may include: receiving, by the CCU, the eCall signal from the DCU through the Ethernet, and receiving, by the ACU, the eCall signal from the CCU through the CAN.

### BRIEF DESCRIPTION OF THE DRAWINGS

FIG. 1 is a view for describing a vehicle according to an embodiment;

FIG. 2 is a view for describing a vehicle according to an embodiment;

FIG. 3 is a view for describing a method for controlling power supply according to an embodiment;

FIG. 4 is a view for describing a method for controlling power supply according to an embodiment;

FIG. 5 is a view for describing a vehicle according to an embodiment;

FIG. 6 is a view for describing a method for controlling power supply according to an embodiment;

FIG. 7 is a view for describing a vehicle according to an embodiment; and

FIG. 8 is a view for describing a computing device according to an embodiment.

### DETAILED DESCRIPTION OF ILLUSTRATIVE EMBODIMENTS

Hereinafter, embodiments of the present disclosure are described in detail with reference to the accompanying drawings so that those skilled in the art to which the present disclosure pertains may easily practice the present disclosure. However, the present disclosure may be implemented in various different forms and is not limited to the embodiments provided herein. In addition, in the drawings, portions unrelated to the description are omitted to clearly describe the present disclosure, and similar portions are denoted by similar reference numerals throughout the specification.

Through the specification and claims, unless explicitly described otherwise, “including” any components will be understood to imply the inclusion of another component rather than the exclusion of another component. Terms including ordinal numbers such as “first” and “second” may be used to describe various components. However, these components are not limited to these terms. These terms are used only to distinguish one component and another component from each other.

Terms such as “˜part” and “module” described in the specification may refer to a unit capable of processing at least one function or operation described in the specification, which may be implemented as hardware, a circuit, software, or a combination of hardware or circuit and software. In addition, at least some of the components or functions for power supply control according to the embodiments described below may be implemented as a program or software, and the program or software may be stored on a computer-readable medium.

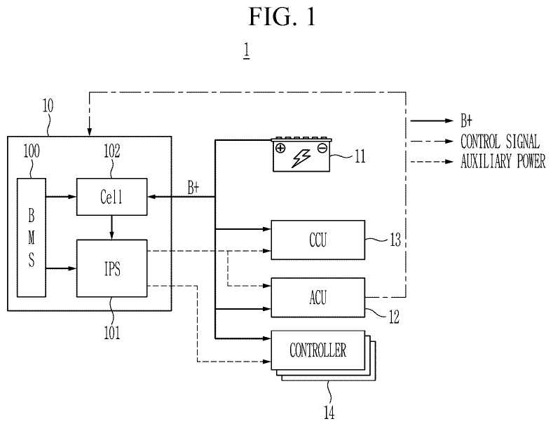

FIG. 1 is a view for describing a vehicle according to an embodiment.

Referring to FIG. 1, a vehicle 1 according to an embodiment may include an auxiliary battery 10, a 12 V battery 11, an airbag control unit (ACU) 12, a central communication unit (CCU) 13, and at least one controller 14. In addition, although not shown in the drawing, the vehicle 1 may further include a high-voltage battery and a computing device including a processor and a storage medium. In some embodiments, the computing device may be implemented to be physically separate from the ACU 12, the CCU 13, and at least one controller 14, and in some other embodiments, the computing device may be implemented to be physically integrated with at least one of the ACU 12, the CCU 13, and at least one controller 14.

The auxiliary battery 10 may include a battery management system (BMS) 100, an intelligent power switch (IPS) 101, and a cell 102. The BMS 100 may monitor a state of the auxiliary battery 10 and perform various control functions. For example, the BMS 100 may monitor the voltage, current, temperature, or the like of the cell 102 in real time to detect an abnormal state, manage a charge state, prevent overcharge, over-discharge, overheating, or the like to maintain battery safety, or optimize performance by balancing the plurality of cells 102. The IPS 101 may be a switching device that controls and manages a power flow. The IPS 101 may adjust the power flow to supply power to a specific circuit or cut off the power.

The 12 V battery or low-voltage battery 11 may be used to supply the power to a low voltage system of the vehicle 1. In some embodiments, the 12 V battery 11 may be manufactured as a lead-acid battery or a lithium-ion battery.

The high-voltage battery may supply the power to drive an electric motor as a main energy source and enable the vehicle 1 to be driven if the vehicle 1 is an electric vehicle. The high-voltage battery may provide a voltage sufficient to drive the electric motor, for example, a voltage of several hundred volts.

The ACU 12 may be an electronic device that controls an airbag system of vehicle 1. The ACU 12 may detect whether the vehicle 1 crashes by collecting data from a sensor installed at the vehicle 1. When the crash is detected, the ACU 12 may immediately issue an instruction to deploy an airbag. In some embodiments, the ACU 12 may record relevant data when the crash occurs. For this purpose, the ACU 12 may include an event data recorder (EDR).

The CCU 13 may manage and transmit various data generated in the vehicle 1. That is, the CCU 13 may manage and adjust communication between the plurality of electronic devices in the vehicle, and may function as a central hub for the plurality of controllers and systems in the vehicle to smoothly interact with each other.

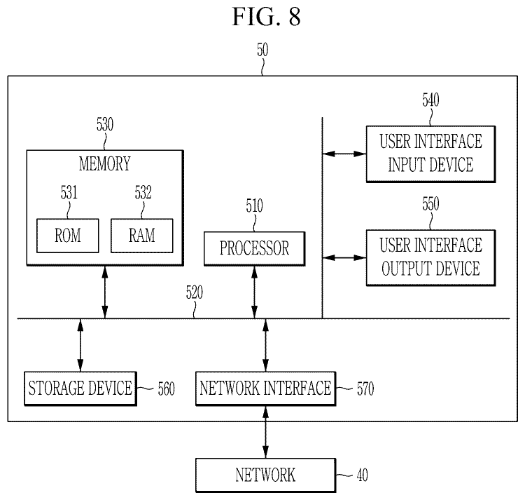

The computing device may execute a program code or an instruction loaded on at least one memory device through at least one processor. For example, the computing device may be implemented as a computing device 50 described below with respect to FIG. 8. For example, at least one processor may correspond to a processor 510 of the computing device 50, and at least one memory device may correspond to a memory 520 of the computing device 50. The program code or the instruction, executed by at least one processor, may control the power supply in the vehicle 1.

The computing device may detect the vehicle crash through the processor. If the crash is detected, the computing device may control the auxiliary battery 10 to supply the power to the ACU 12 and the CCU 13 through the processor.

In detail, in order to detect a vehicle crash, the computing device may determine whether a second ignition circuit IGN2 of the vehicle is in an ON state. The computing device may charge the auxiliary battery 10 by using the high-voltage battery if the second ignition circuit IGN2 is determined to be in the ON state. On the other hand, the computing device may detect the crash of vehicle 1 if the second ignition circuit IGN2 is determined to be in an OFF state. The computing device may charge the auxiliary battery 10 by using the 12 V battery 11 of the vehicle 1 if the crash of vehicle 1 is not detected.

IGN1 may be referred to as “first ignition circuit” or simply “Ignition 1,” and IGN2 may be referred to as “second ignition circuit” or simply “Ignition 2.” IGN1 may be a circuit activated when an ignition switch is in the “START” position and may be responsible for supplying power for starting the engine. Once the ignition switch moves to the “RUN” position, IGN1 may continue to operate alongside IGN2. IGN1 may primarily provide essential power to the engine's ignition system, which is critical for starting and running the engine. In contrast, IGN2 may be activated in the “RUN” position and supply power to various auxiliary components in the vehicle.

In order to charge the auxiliary battery 10 by using the high-voltage battery of the vehicle 1, the computing device may determine whether a state of charge (SOC) of the auxiliary battery 10 is a predetermined first threshold or more. The computing device may start charging the auxiliary battery 10 by using the high-voltage battery if the SOC of the auxiliary battery 10 is determined to be less than the first threshold. The computing device may terminate the charging if the SOC of the auxiliary battery 10 is determined to be the first threshold or more after the charging starts.

In order to charge the auxiliary battery 10 by using the 12 V battery of the vehicle 1, the computing device may determine whether the SOC of the auxiliary battery 10 is a predetermined second threshold or more. The computing device may determine whether the SOC of the 12 V battery 11 is a predetermined third threshold or more if the SOC of the auxiliary battery 10 is determined to be less than the second threshold. The computing device may start charging the auxiliary battery 10 by using the 12 V battery 11 if the SOC of the 12 V battery 11 is determined to be the third threshold or more. The computing device may terminate the charging if the SOC of the auxiliary battery 10 is determined to be the second threshold or more after the charging starts.

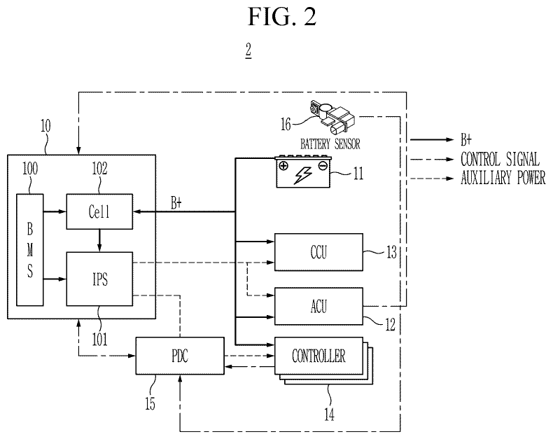

FIG. 2 is a view for describing a vehicle according to an embodiment.

Referring to FIG. 2, a vehicle 2 according to an embodiment may include the auxiliary battery 10, the 12 V battery 11, the ACU 12, the CCU 13, at least one controller 14, a power-net domain controller (PDC) 15, and a 12 V battery sensor 16. In addition, although not shown in the drawing, the vehicle 2 may further include the computing device including the processor and the storage medium, and the high-voltage battery.

Descriptions of the auxiliary battery 10, the 12 V battery 11, the ACU 12, the CCU 13, at least one controller 14, the computing device, and the high-voltage battery may refer to the descriptions provided above with reference to FIG. 1 to the extent that the corresponding descriptions do not contradict this embodiment.

The PDC 15 may be an electronic device that efficiently distributes the power to various electrical loads in the vehicle 2. In particular, the PDC 15 may control the power flow between the high-voltage battery, the 12 V battery, and the auxiliary battery.

In this embodiment, the PDC 15 may be operated between the auxiliary battery 10 and at least one controller 14. The PDC 15 may receive a parking power supply request signal from at least one controller 14. Here, the parking power supply request signal may be a signal indicating that the power supply is required for at least one controller 14 while the vehicle 1 is parked. The PDC 15 may determine which battery between the 12 V battery 11 and the auxiliary battery 10 to supply the power to at least one controller 14 based on the parking power supply request signal. The computing device may control the battery determined by the PDC 15 to supply the power to at least one controller 14.

To determine which battery to supply the power to at least one controller 14, the PDC 15 may determine whether the SOC of the 12 V battery 11 is a predetermined fourth threshold or more. The PDC 15 may determine the 12 V battery 11 as the battery to supply the power to at least one controller 14 if the SOC of the 12 V battery 11 is determined to be the fourth threshold or more. On the other hand, the PDC 15 may determine whether the SOC of the auxiliary battery 10 is a predetermined fifth threshold or more if the SOC of the 12 V battery 11 is determined to be less than the fourth threshold. The PDC 15 may determine the auxiliary battery 10 as the battery to supply the power to at least one controller 14 if the SOC of the auxiliary battery 10 is determined to be the fifth threshold or more.

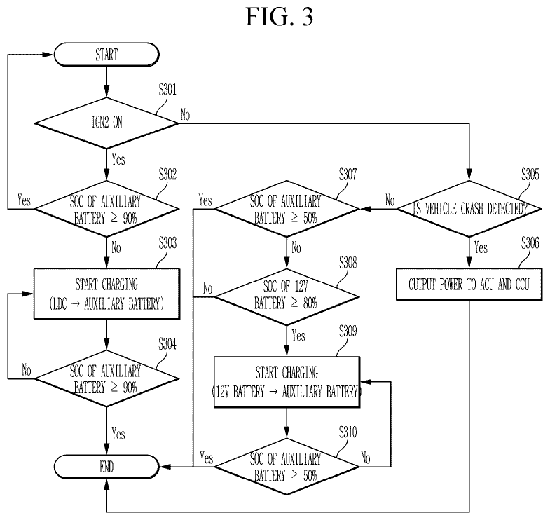

FIG. 3 is a view for describing a method for controlling power supply according to an embodiment.

Referring to FIG. 3, the method for controlling power supply according to an embodiment may include determining, by a processor, whether a second ignition circuit IGN2 of a vehicle is in an ON state (S301).

The method may include charging, by the processor, an auxiliary battery mounted in the vehicle by using a high-voltage battery of the vehicle if the second ignition circuit IGN2 is determined to be in the ON state (“Yes” in S301). In detail, the method may include determining, by the processor, whether a state of charge (SOC) of the auxiliary battery is a predetermined first threshold or more, for example, 90% or more (S302). The method may include starting, by the processor, charging the auxiliary battery by using the high-voltage battery (S303) if the SOC of the auxiliary battery is determined to be less than the first threshold (No in S302). Here, a low voltage direct current to direct current (DC-DC) converter (LDC) may be used to convert a voltage of the high-voltage battery to a low voltage.

The method may include determining, by the processor, whether the SOC of the auxiliary battery is the predetermined first threshold or more, for example, 90% or more, after the charging starts (S304). The method may include terminating, by the processor, the charging if the SOC of the auxiliary battery is determined to be the first threshold or more (‘Yes’ in S304). On the other hand, the method may proceed to step S303 if the SOC of the auxiliary battery is determined to be less than the first threshold (‘No’ in S304).

The method may include detecting, by the processor, a vehicle crash if the second ignition circuit IGN2 is determined to be in an OFF state (“No” in S301). The method may include controlling, by the processor, the auxiliary battery to supply power to the airbag control unit (ACU) and central communication unit (CCU) of the vehicle (S306) if the vehicle crash is detected (“Yes” in S305).

The method may include charging, by the processor, the auxiliary battery by using a 12 V battery of the vehicle if the vehicle crash is not detected (“No” in S305). In detail, the method may include determining, by the processor, whether the SOC of the auxiliary battery is a predetermined second threshold or more, for example, 50% or more (S307). The method may include determining, by the processor, whether a SOC of the 12 V battery is a predetermined third threshold or more, for example, 80% or more (S308) if the SOC of the auxiliary battery is determined to be less than the second threshold (“No” in S307). The method may include starting, by the processor, charging the auxiliary battery by using the 12 V battery (S309) if the SOC of the 12 V battery is determined to be the third threshold or more. The method may include determining, by the processor, whether the SOC of the auxiliary battery is the predetermined second threshold or more, for example, 50% or more, after the charging starts (S310). The charging may be terminated by the processor if the SOC of the auxiliary battery is determined to be the second threshold or more (“Yes” in S310). On the other hand, the method may proceed to step S309 if the SOC of the auxiliary battery is determined to be less than the second threshold (“No” in S310).

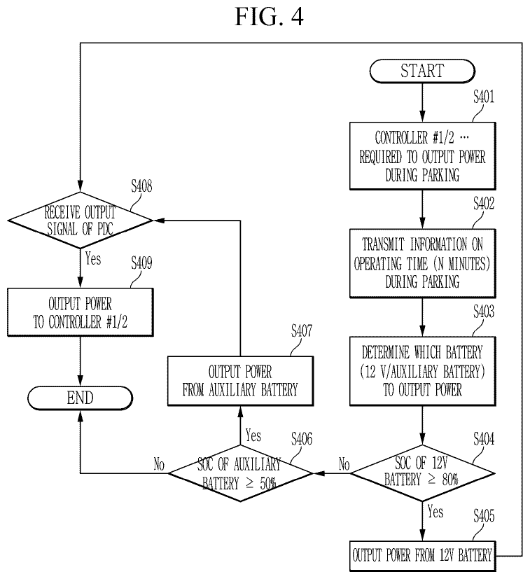

FIG. 4 is a view for describing a method for controlling power supply according to an embodiment.

Referring to FIG. 4, the method for controlling power supply according to an embodiment may include: receiving, by a power-net domain controller (PDC), a parking power supply request signal from a controller (S401); transmitting, by the PDC, information on an operating time during parking (S402); determining, by the PDC, which battery between a 12 V battery and an auxiliary battery to supply power to the controller based on the parking power supply request signal (S403); and determining, by the PDC, whether a state of charge (SOC) of the 12 V battery is a predetermined fourth threshold or more, for example, 80% or more (S404).

The method may include determining, by the PDC, the 12 V battery as the battery to supply the power to the controller (S405) if the SOC of the 12 V battery is determined to be the fourth threshold or more (‘Yes’ in S404).

The method may include determining, by the PDC, whether a SOC of the auxiliary battery is a predetermined fifth threshold or more, for example, 50% or more (S406) if the SOC of the 12 V battery is determined to be less than the fourth threshold (“No” in S404). The method may include determining, by the PDC, the auxiliary battery as the battery to supply the power to the controller (S407) if the SOC of the auxiliary battery is determined to be the fifth threshold or more (“Yes” in S406).

The method may include determining whether an output signal of the PDC is received (S408) and controlling, by the processor, to supply the power to the controller from the battery determined by the PDC (S409) after step S405 or step S407.

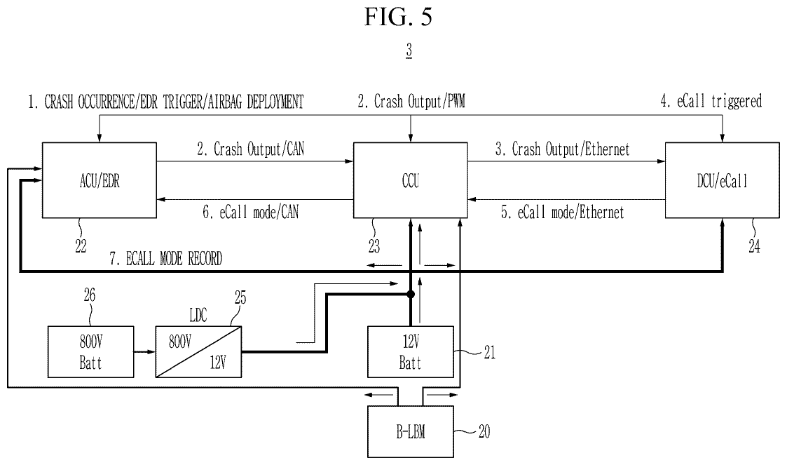

FIG. 5 is a view for describing a vehicle according to an embodiment.

Referring to FIG. 5, a vehicle 3 according to an embodiment may include an auxiliary battery 20, a 12 V battery 21, an airbag control unit (ACU) 22, a central communication unit (CCU) 23, a data connectivity unit (DCU) 24, a low voltage direct current to direct current (DC-DC) converter (LDC) 25, and a high-voltage battery 26. In addition, although not shown in the drawing, the vehicle 1 may further include a computing device including a processor and a storage medium. In some embodiments, the computing device may be implemented to be physically separate from the ACU 22, the CCU 23, and the DCU 24, and in some other embodiments, the computing device may be implemented to be physically integrated with at least one of the ACU 22, the CCU 23, and the DCU 24.

Descriptions of the auxiliary battery 20, the 12 V battery 21, the ACU 22, the CCU 23, the computing device, and the high-voltage battery 26 may refer to the descriptions provided above with reference to FIGS. 1 and 2 to the extent that the corresponding descriptions do not contradict this embodiment.

The DCU 24 may be an electronic device that manages data communication inside and outside the vehicle 3. That is, the DCU 24 may function as a hub to exchange data between the plurality of electronic devices in the vehicle and an external network.

An emergency call (eCall) may be a safety function for automatically connecting to an emergency service such as an emergency rescue agency and sending a rescue request when a vehicle crash occurs. The eCall system may automatically attempt to send the rescue request to the emergency service when the vehicle is involved in a serious crash, such as when its airbag deploys. In addition, the eCall system may support a function such as allowing a driver to manually make the emergency call by pressing a button, transmitting an exact location of the vehicle to the emergency service through a global positioning system (GPS), or enabling voice communication between the vehicle and the emergency service. That is, when the crash occurs, the rescue request may be automatically made by the eCall, which may ensure passenger safety when the crash occurs.

Meanwhile, an event data recorder (EDR) may collect the data from the various sensors or electronic devices of the vehicle. For example, if the vehicle crash is detected, the EDR may record important data before and after the crash, such as a vehicle speed, a brake state, an accelerator pedal position, seat belt fastening, a steering angle, an airbag deployment, or the like. When the eCall system is automatically triggered, the EDR may record crash data in conjunction with the system. For example, the EDR may also record information such as the location, time, driving route, or the like of the vehicle that is transmitted from the eCall system.

An eCall automatic trigger and an EDR recording logic may each perform a series of processes including, for example, seven steps to normally record the data after the vehicle crash. The data may be recorded up to seven steps through the series of processes performed by the eCall automatic trigger and the EDR recording logic. For example, the eCall automatic trigger and EDR recording logic may each perform: step 1 of the ACU 22 for detecting a crash occurrence, triggering the EDR, and deploying the airbag, step 2 of the ACU 22 for outputting a crash signal to the CCU 23 and DCU 24, step 3 of the CCU 23 for outputting the crash signal to the DCU 24, step 4 for triggering the eCall, step 5 of the DCU 24 for outputting an eCall signal to the CCU 23, step 6 of the CCU 23 for outputting the eCall signal to the ACU 22, and step 7 of the ACU 22 for recording an eCall status in the EDR. However, the normal EDR recording may not be performed if power supply of the ACU 22 or CCU 23, which is responsible for the EDR recording, is lost due to the vehicle crash.

In order to prevent a situation where the EDR recording is incompletely performed due to a loss of main power, the auxiliary battery 20 may be used as power supply means to implement a power supply system that enables the normal EDR recording without signal interruption when the crash occurs by using the auxiliary battery 20 as power supply means. This configuration may ensure that all essential data is recorded and the EDR system is smoothly operated through stable power supply even when the crash occurs.

In some embodiments, the auxiliary battery may include a built-in cam battery module (B-LBM) that supplies the power to a built-in camera of the vehicle 3.

The computing device may detect the crash based on a front impact sensor (FIS) of the vehicle 3 through the processor. Here, the FIS may be a sensor for detecting the crash in front of the vehicle, and may be installed on a front part of the vehicle 3 for example.

The computing device may check, through the processor, whether the power supplied from the high-voltage battery 26 of the vehicle 3 through LDC 25 and the power supplied from the 12 V battery 21 of the vehicle 3 is lost if the crash is detected. The check for power loss may be performed by monitoring a voltage supplied from the high-voltage battery 26 and the 12 V battery 21, checking a power supply state signal for the LDC 25 and the 12 V battery 21, or checking whether a current flows from the LDC 25 and the 12 V battery 21.

The computing device may control the auxiliary battery 20 to supply the power to the ACU 22 and the CCU 23 through the processor if the power supplied from the high-voltage battery 26 and the power supplied from the 12 V battery 21 are checked to be lost.

In some embodiments, the method described above may be applied if the DCU 24 has its own built-in battery, and in some other embodiments, the power supply by the auxiliary battery 20 may be applied to the DCU 24 in a similar manner as described above.

The ACU 22 may then output the crash signal to the CCU 23 and the DCU 24. In detail, for example, the ACU 22 may output the crash signal to the CCU 23 through a controller area network (CAN), the CCU 23 may output the crash signal to the DCU 24 through Ethernet, and the ACU 22 may output the crash signal to the DCU 24 through pulse-width modulation (PWM). Next, the ACU 22 may receive the eCall signal triggered from the DCU 24 based onthe crash signal. In detail, for example, the CCU 23 may receive the eCall signal from the DCU 24 through Ethernet, and the ACU 22 may receive the eCall signal from the CCU 23 through the CAN. The ACU 23 may then record the eCall status in the EDR.

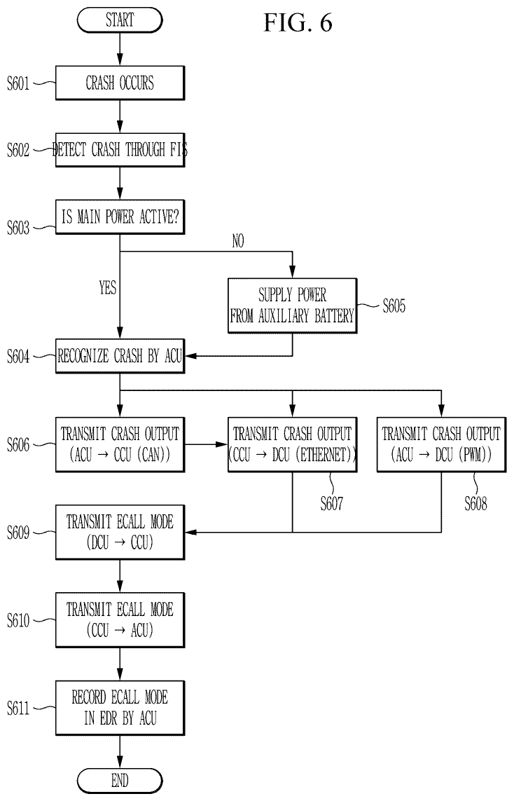

FIG. 6 is a view for describing a method for controlling power supply according to an embodiment.

Referring to FIG. 6, the method for controlling power supply according to an embodiment may include: detecting, by a processor, a crash through a front impact sensor (FIS) of a vehicle (S601 and S602); and checking, by the processor, whether main power is active, that is, whether power supplied from a high-voltage battery of the vehicle and power supplied from a 12 V battery of the vehicle are lost if the crash is detected (S603).

The method may include controlling, by the processor, an auxiliary battery mounted in the vehicle to supply the power to the airbag control unit (ACU) and central communication unit (CCU) of the vehicle (S605) if the main power is checked as inactive, that is, if the power supplied from the high-voltage battery and the power supplied from the 12 V battery are checked as being lost (“No” in S603).

The method may include recognizing, by the ACU, the crash (S604) without performing the step S605 if the main power is checked as active, that is, the power supplied from the high-voltage battery and the power supplied from the 12 V battery are checked as not lost (“Yes” in S603).

The method may then include: outputting, by the ACU, the crash signal to the CCU through a controller area network (CAN) (S606); outputting, by the CCU, the crash signal to a data connectivity unit (DCU) through Ethernet (S607); and outputting, by the ACU, the crash signal to the DCU through pulse-width modulation (PWM) (S608).

The method may then include: receiving, by the CCU, an emergency call (eCall) signal from the DCU through Ethernet (S609); receiving, by the ACU, the eCall signal from the CCU through the CAN (S610); and recording, by the ACU, an eCall status in an event data recorder (EDR) (S611).

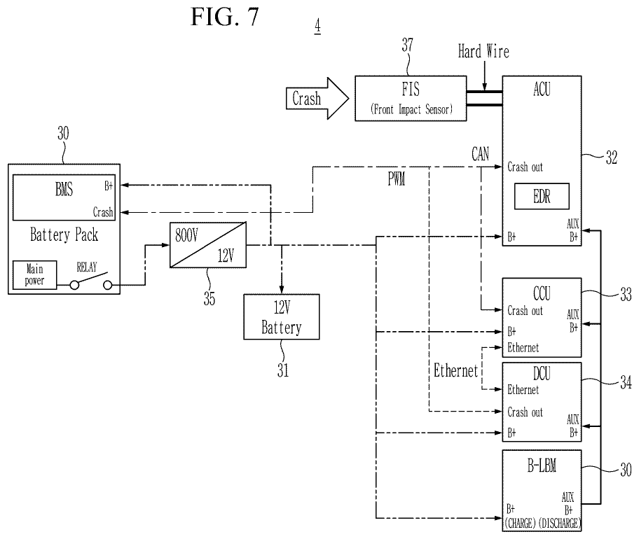

FIG. 7 is a view for describing a vehicle according to an embodiment.

Referring to FIG. 7, an airbag control unit (ACU) 32 may detect a crash through a front impact sensor (FIS) 37 connected thereto by a hard wire when the crash of a vehicle 4 occurs. Here, the crash may cause a loss of main power, that is, power supplied from a high-voltage battery 36 through a low voltage direct current to direct current (DC-DC) converter (LDC) 35 and power supplied from a 12 V battery 31. For example, an auxiliary battery 30 mounted on the vehicle 4 may supply the power to the ACU 32, a central communication unit (CCU) 33, and a data connectivity unit (DCU) 34.

In some embodiments, the ACU 32 may transmit a crash signal to each controller. In detail, the ACU 32 may transmit the crash signal to a battery management system (BMS) of the high-voltage battery 36, and the BMS may cut off the power by opening a relay based on the received crash signal. In some embodiments, the BMS may cut off the power by opening the relay after a predetermined time, for example, 1,600 ms, after receiving the crash signal from the ACU 32. When the relay is opened, the power may be supplied from the auxiliary battery 30 to each controller.

The ACU 32 may then transmit the crash signal to the CCU 33 through a controller area network (CAN) and transmit the crash signal to the DCU 34 through pulse-width modulation (PWM). In addition, the CCU 33 may transmit the crash signal to the DCU 34 through Ethernet.

The DCU 34, which receives the crash signal, may trigger an emergency call (eCall), and the DCU 34 may transmit an eCall signal indicating that the eCall is normally triggered to the CCU 33 through Ethernet. In addition, the CCU 33 may transmit the eCall signal to the ACU 32 through the CAN. The ACU 32 may record an eCall status in an event data recorder (EDR) based on the eCall signal received from the CCU 33.

FIG. 8 is a view for describing the computing device according to an embodiment.

Referring to FIG. 8, the method for controlling power supply according to the embodiments may be implemented using the computing device 50. The computing device 50 may be implemented as any of various types of electronic devices, servers, or similar devices, and its function may be implemented through a combination of software and hardware.

The computing device 50 may include at least one of the processor 510, a memory 530, a user interface input device 540, a user interface output device 550, and a storage device 560, performing their communications with one another using a bus 520. The computing device 50 may also include a network interface 570 electrically connected to a network 40. The network interface 570 may transmit or receive a signal with another entity through the network 40.

The processor 510 may be implemented as any of various types of computing units, such as a micro controller unit (MCU), an application processor (AP), a central processing unit (CPU), a graphic processing unit (GPU), a neural processing unit (NPU), or a quantum processing unit (QPU). The processor 510 may also be a semiconductor device that executes an instruction stored in the memory 530 or the storage device 560, and may perform a core function of a system. A program code and data stored in the memory 530 or the storage device 560 may instruct the processor 510 to perform a specific task, thereby enabling overall operations of the system. In this way, the processor 510 may be configured to implement the various functions and methods described above with respect to FIGS. 1 to 7.

The memory 530 and the storage device 560 may include various forms of volatile or non-volatile storage media for storing and accessing data of the system. For example, the memory 530 may include a read only memory (ROM) 531 and a random access memory (RAM) 532. In some embodiments, the memory 530 may be embedded in the processor 510, in which case data transmission between the memory 530 and the processor 510 may be performed at a very fast speed. In some other embodiments, the memory 530 may be disposed outside the processor 510, in which case the memory 530 may be connected to the processor 510 through various data buses or interfaces. This connection may be made by various means already known, for example, through a peripheral component interconnect express (PCIe) interface for high-speed data transmission or through a memory controller.

In some embodiments, at least some components or functions of the method and device for the power supply control according to the embodiments may be implemented as a program or software executed on the computing device 50, and the program or software may be stored in the computer-readable medium. In detail, the computer-readable medium according to an embodiment may be a computer program for executing the steps included in the implementation of the power supply control according to the embodiments that is recorded on a computer including the processor 510 for executing the program or the instruction, stored in the memory 530 or the storage device 560.

In some embodiment, at least some components or functions for the power supply control according to the embodiments may be implemented using the hardware or circuitry of the computing device 50, or implemented using a separate hardware or circuitry that may be electrically connected to the computing device 50.

According to the embodiments, it is possible to enable the continuous power supply to the target controller by installing the auxiliary battery without new development of the conventional controller in the crash situation such as the responding to the crash regulation. In this way, it is possible to increase the safety of the vehicle while reducing the additional development cost. In addition, it is possible to minimize the negative impact on the power efficiency by applying the charging and discharging control of the auxiliary battery to optimize the power consumption of the vehicle. This control may contribute to maintaining the energy efficiency of the vehicle while preventing its overall performance degradation. It is possible to prevent the discharge of the 12 V battery during the parking by using the power of the auxiliary battery in the specific situation. In this way, it is possible to extend the lifespan of the battery and reduce the inconvenience caused by its unexpected discharge. In addition, it is possible to secure the emergency power required in the crash situation through the supplementary power from the 12 V battery if the charge level of the auxiliary battery falls to the certain level or below. In this way, it is possible to enable the stable power supply even during the crash, further improving the safety. In addition, it is possible to improve the customer convenience and secure the expandability of the vehicle function by configuring the system that enables the continuous power supply to the target controller even during the parking in the specific situation. This configuration may support the vehicle to stably operate the various electronic devices even during the parking, and contribute to improving the user experience. Finally, it is possible to variably apply the capacity of the auxiliary battery, thus suppressing the unnecessary cost increase. In this way, it is possible to expect the function of the optimized auxiliary power supply source based on the vehicle type or the usage case, and provide the flexibility to be applied to the various vehicle models.

In addition, according to the embodiments, it is possible to provide the method for solve the problem of vehicle sales caused by the unsatisfactory EDR authentication when the main power (high-voltage battery or 12 V lead battery) supply source is lost due to the crash. That is, it is possible to configure the system for normally performing the EDR authentication through the power supply to the ACU and CCU by installing the additional auxiliary battery in order to satisfy the EDR authentication even if the main power supply source is lost. In particular, according to embodiments, it is possible to design the system for the EDR to be recorded and authenticated in any case by installing the auxiliary battery in the situation where it is uncertain whether the main power is lost when the crash occurs. This configuration may perform the important function in overcoming the difficulties of the EDR authentication that may occur during the crash.

Although the embodiments of the present disclosure have been described in detail hereinabove, the scope of the present disclosure is not limited thereto, and various modifications and alterations made by those skilled in the art to which the present disclosure pertains by using a basic concept of the present disclosure as defined in the following claims also fall within the scope of the present disclosure.

What is claimed is:

1. A method for controlling power supply, the method comprising:
determining, by a processor of a vehicle, whether an ignition circuit of the vehicle is in an ON state or an OFF state;
based on determining that the ignition circuit is in the ON state, charging, by the processor, an auxiliary battery of the vehicle by using a high-voltage battery of the vehicle; and
based on determining that the ignition circuit is in the OFF state, determining, by the processor, whether a crash of the vehicle is detected:
based on detecting the crash, controlling, by the processor, the auxiliary battery to supply power to an airbag control unit (ACU) of the vehicle; and
based on not detecting the crash, charging, by the processor, the auxiliary battery by using a low-voltage battery of the vehicle.

2. The method of claim 1, wherein the controlling the auxiliary battery to supply the power to the ACU of the vehicle includes controlling, by the processor, the auxiliary battery to also supply the power to a central communication unit (CCU) of the vehicle.

3. The method of claim 1, wherein charging the auxiliary battery by using the high-voltage battery of the vehicle includes:
determining, by the processor, whether a state of charge (SOC) of the auxiliary battery is a predetermined first threshold or more;
starting, by the processor, charging the auxiliary battery by using the high-voltage battery based on determining that the SOC of the auxiliary battery is less than the first threshold; and
terminating, by the processor, charging based on determining that the SOC of the auxiliary battery is the first threshold or more after the charging started.

4. The method of claim 1, wherein charging the auxiliary battery by using the low-voltage battery of the vehicle includes:
determining, by the processor, whether a state of charge (SOC) of the auxiliary battery is a predetermined second threshold or more;
determining, by the processor, a state of charge (SOC) of the low-voltage battery is a predetermined third threshold or more based on determining that the SOC of the auxiliary battery is less than the second threshold;
starting, by the processor, charging the auxiliary battery by using the low-voltage battery based on determining that the SOC of the low-voltage battery is the third threshold or more; and
terminating, by the processor, the charging based on determining that the SOC of the auxiliary battery is the second threshold or more after the charging started.

5. The method of claim 1,
wherein the vehicle further includes a power-net domain controller (PDC) operated between the auxiliary battery and the processor, and
wherein the method further comprises:
receiving, by the PDC, a parking power supply request signal from the controller;
determining, by the PDC, which of the low-voltage battery and the auxiliary battery to supply the power to the controller based on the parking power supply request signal; and
controlling, by the processor, the battery determined by the PDC to supply the power to the controller.

6. The method of claim 5, wherein determining which of the low-voltage battery and the auxiliary battery to supply the power to the controller includes:
determining, by the PDC, whether a state of charge (SOC) of the low-voltage battery is a predetermined fourth threshold or more; and
determining, by the PDC, the low-voltage battery as the battery to supply the power to the controller based on determining that the SOC of the low-voltage battery is the fourth threshold or more.

7. The method of claim 6, wherein determining which of the low-voltage battery and the auxiliary battery to supply the power to the controller includes:
determining, by the PDC, whether a state of charge (SOC) of the auxiliary battery is a predetermined fifth threshold or more based on determining that the SOC of the low-voltage battery is less than the fourth threshold; and
determining, by the PDC, the auxiliary battery as the battery to supply the power to the controller based on determining that the SOC of the auxiliary battery is the fifth threshold or more.

8. A method for controlling power supply, the method comprising:
detecting, by a processor of a vehicle, a crash by a sensor of the vehicle;
determining by the processor, whether power supplied from a high-voltage battery of the vehicle and power supplied from a low-voltage battery of the vehicle are interrupted based on detecting the crash;
controlling, by the processor, an auxiliary battery of the vehicle to supply the power to an airbag control unit (ACU) and a central communication unit (CCU) of the vehicle based on determining that the power supplied from the high-voltage battery and the power supplied from the low-voltage battery are interrupted;
outputting, by the ACU, a crash signal to the CCU and to a data connectivity unit (DCU) of the vehicle;
receiving, by the ACU, an emergency call (eCall) signal triggered from the DCU based on the crash signal; and
recording, by the ACU, an eCall status in an event data recorder (EDR).

9. The method of claim 8, wherein outputting, by the ACU, the crash signal to the CCU and the DCU of the vehicle includes:
outputting, by the ACU, the crash signal to the CCU through a controller area network (CAN);
outputting, by the CCU, the crash signal to the DCU through Ethernet; or
outputting, by the ACU, the crash signal to the DCU through pulse-width modulation (PWM).

10. The method of claim 9, wherein receiving, by the ACU, the eCall signal triggered from the DCU includes:
receiving, by the CCU, the eCall signal from the DCU through the Ethernet; or
receiving, by the ACU, the eCall signal from the CCU through the CAN.

11. A vehicle comprising:
a computing device including a processor and a storage medium;
a high-voltage battery, a low-voltage battery, and an auxiliary battery configured for supplying power;
an airbag control unit (ACU); and
a central communication unit (CCU),
wherein the processor is configured for:
detecting a crash of the vehicle; and
controlling the auxiliary battery to supply the power to the ACU and the CCU based on detecting the crash.

12. The vehicle of claim 11, wherein the processor is configured for detecting the crash by determining whether an ignition circuit of the vehicle is in an ON state or an OFF state;
based on determining that the ignition circuit is in the ON state, charging the auxiliary battery by using the high-voltage battery of the vehicle;
based on determining that the ignition circuit is in the OFF state, detecting the crash; and
based on not detecting the crash, charging the auxiliary battery by using the low-voltage battery of the vehicle.

13. The vehicle of claim 12, wherein charging the auxiliary battery by using the high-voltage battery of the vehicle includes:
determining whether a state of charge (SOC) of the auxiliary battery is a predetermined first threshold or more;
starting charging the auxiliary battery by using the high-voltage battery based on determining that the SOC of the auxiliary battery is less than the first threshold; and
terminating the charging based on determining that the SOC of the auxiliary battery is the first threshold or more after the charging started.

14. The vehicle of claim 12, wherein charging the auxiliary battery by using the low-voltage battery of the vehicle includes:
determining whether a state of charge (SOC) of the auxiliary battery is a predetermined second threshold or more;
determining whether a state of charge (SOC) of the low-voltage battery is a predetermined third threshold or more based on determining that the SOC of the auxiliary battery is less than the second threshold;
starting charging the auxiliary battery by using the low-voltage battery based on determining that the SOC of the low-voltage battery is the third threshold or more; and
terminating the charging based on determining that the SOC of the auxiliary battery is the second threshold or more after the charging started.

15. The vehicle of claim 11, further comprising:
a controller; and
a power-net domain controller (PDC) operated between the auxiliary battery and the controller, wherein the PDC is configured for:
receiving a parking power supply request signal from the controller; and
determining which of the low-voltage battery and the auxiliary battery to supply the power to the controller based on the parking power supply request signal, and
wherein the processor is configured for controlling the battery determined by the PDC to supply the power to the controller.

16. The vehicle of claim 15, wherein determining which of the low-voltage battery and the auxiliary battery to supply the power to the controller includes:
determining whether a state of charge (SOC) of the low-voltage battery is a predetermined fourth threshold or more; and
determining the low-voltage battery as the battery to supply the power to the controller based on determining that the SOC of the low-voltage battery is the fourth threshold or more.

17. The vehicle of claim 16, wherein determining which of the low-voltage battery and the auxiliary battery to supply the power to the controller includes:
determining whether a state of charge (SOC) of the auxiliary battery is a predetermined fifth threshold or more based on determining that the SOC of the low-voltage battery is less than the fourth threshold; and
determining the auxiliary battery as the battery to supply the power to the controller based on determining that the SOC of the auxiliary battery is the fifth threshold or more.

18. The vehicle of claim 11, wherein detecting the crash includes detecting the crash through a sensor of the vehicle, and
wherein controlling the auxiliary battery to supply the power to the ACU and the CCU based on detecting the crash includes:
checking whether the power supplied from the high-voltage battery and the power supplied from the low-voltage battery are interrupted based on detecting the crash,
controlling the auxiliary battery to supply the power to the ACU and the CCU of the vehicle based on detecting that the power supplied from the high-voltage battery and the power supplied from the low-voltage battery are interrupted, and
wherein the ACU is configured for:
outputting a crash signal to the CCU and a data connectivity unit (DCU) of the vehicle,
receiving an emergency call (eCall) signal triggered from the DCU based on the crash signal, and
records an eCall status in an event data recorder (EDR).

19. The vehicle of claim 18, wherein outputting the crash signal to the CCU and the DCU of the vehicle includes:
outputting, by the ACU, the crash signal to the CCU through a controller area network (CAN),
outputting, by the CCU, the crash signal to the DCU through Ethernet, or
outputting, by the ACU, the crash signal to the DCU through pulse-width modulation (PWM).

20. The vehicle of claim 19, wherein receiving the eCall signal triggered from the DCU includes:
receiving, by the CCU, the eCall signal from the DCU through the Ethernet, and
receiving, by the ACU, the eCall signal from the CCU through the CAN.
